(19) United States
(12) Patent Application Publication
(10) Pub. No.: US 2011/0291936 A1
(43) Pub. Date: Dec. 1, 2011

(54) TOUCH-TYPE TRANSPARENT KEYBOARD

(75) Inventors: KUN-TSAN WU, Shindian (TW); LI-WEN TIEN, Shindian (TW)

(73) Assignee: FIH (HONG KONG) LIMITED, Kowloon (HK)

(21) Appl. No.: 12/889,569

(22) Filed: Sep. 24, 2010

(30) Foreign Application Priority Data
May 28, 2010 (CN) 201010185008.1

(51) Int. Cl. G06F 3/041; G06F 3/02

(52) U.S. Cl. 345/168; 345/173

(57) ABSTRACT

A touch-type transparent keyboard is for use with an electronic device. The touch-type transparent keyboard includes a touch screen, a control module electrically connecting to the touch screen, a transparent plate and a keyboard layer. The keyboard layer includes a number of key icons. The keyboard layer is disposed between the touch screen and the transparent plate. When a touching position corresponding to the key icons of the touch screen are touched, the control module detects a touch position coordinate and produces a corresponding command signal to the electronic device, and an image is shown on the electronic device.

### CROSS-REFERENCE TO RELATED APPLICATIONS

This application is one of the six related co-pending U.S. patent applications listed below. All listed applications have the same assignee and were concurrently filed herewith. The disclosure of each of the listed applications is incorporated by reference into all the other listed applications.

| Attorney Docket No. | Title | Inventors |
|---|---|---|
| US33515 | TOUCH-TYPE TRANSPARENT | Wu et al. |
| | KEYBOARD | |
| US33516 | TOUCH-TYPE TRANSPARENT | Wu et al. |
| | KEYBOARD | |
| US33517 | TOUCH-TYPE TRANSPARENT | Wu et al. |
| | KEYBOARD | |
| US33518 | TOUCH-TYPE TRANSPARENT | Wu et al. |
| | KEYBOARD | |
| US33519 | TOUCH-TYPE TRANSPARENT | Wu et al. |
| | KEYBOARD | |
| US33520 | TOUCH-TYPE TRANSPARENT | Wu et al. |
| | KEYBOARD | |

### BACKGROUND

1. Technical Field

The present disclosure generally relates to touch-type transparent keyboards, and particularly, to a touch-type transparent keyboard for use with an electronic device.

2. Description of Related Art

For operating electronic devices, keyboards, mice, trackballs or remote controls are important user interfaces for controlling cursors or inputting instructions. Currently, standard mechanical keyboards are widely for use with industrial or residential fields for inputting information to computers. Mechanical keyboards may make noise while being used for typing. Moreover, gaps between keys can be a gathering point for contaminants.

Therefore, there is a room for improvement within the art.

### BRIEF DESCRIPTION OF THE DRAWINGS

Many aspects of the touch-type transparent keyboard can be better understood with reference to the following drawings. The components in the drawings are not necessarily to scale, the emphasis instead being placed upon clearly illustrating the touch-type transparent keyboard. Moreover, in the drawings, like reference numerals designate corresponding parts throughout the several views.

FIG. 1 is an exploded and isometric view of a touch-type transparent keyboard, according to an exemplary embodiment.

FIG. 2 is a cross-sectional view of the touch-type transparent keyboard shown in FIG. 1.

FIG. 3 is an assembled, isometric view of the touch-type transparent keyboard shown in FIG. 1.

FIG. 4 is an assembled, isometric view of the touch-type transparent keyboard shown in FIG. 3, but shown from another angle.

### DETAILED DESCRIPTION

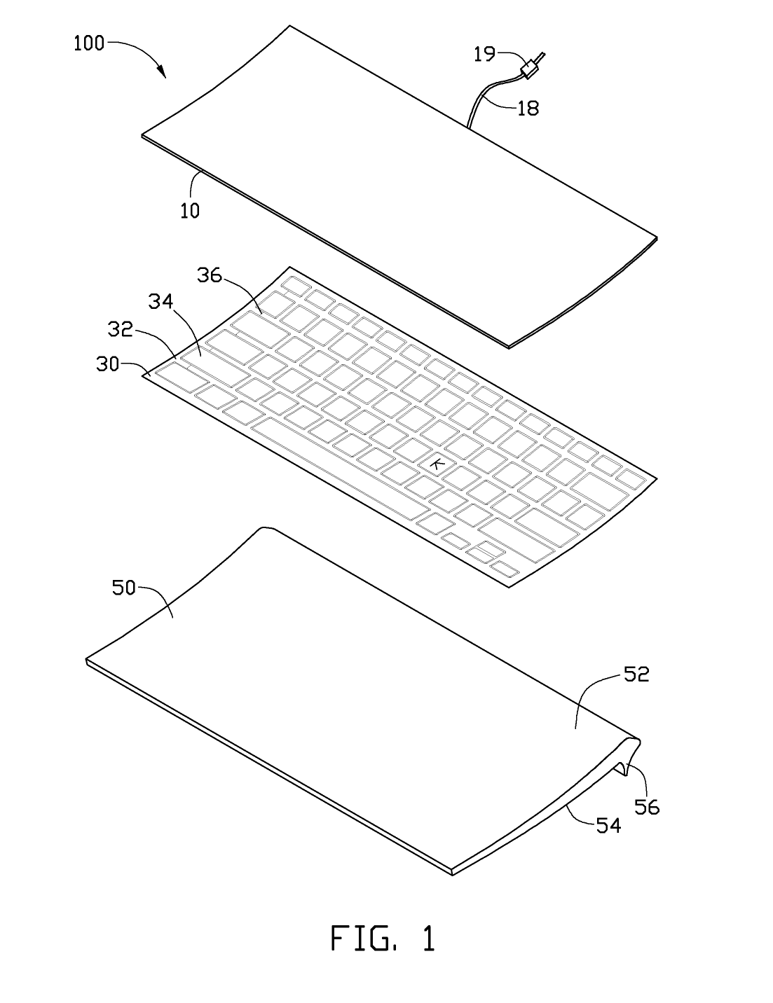

Referring FIG. 1, the present disclosure provides a touch-type transparent keyboard 100 for use with an electronic device. The electronic device includes but is not limited to a smart phone, a mobile phone, a personal digital assistant (PDA), an e-book reader, or a notebook computer. In an exemplary embodiment, the touch-type transparent keyboard 100 includes a touch screen 10, a keyboard layer 30, and a transparent plate 50. The keyboard layer 30 is disposed between the touch screen 10 and the transparent plate 50. The touch screen 10, the keyboard layer 30, and the transparent plate 50 combine together for forming the touch-type transparent keyboard 100. Using a finger or a touching tool to touch the touch screen 10, users can input an instruction to control the electronic device.

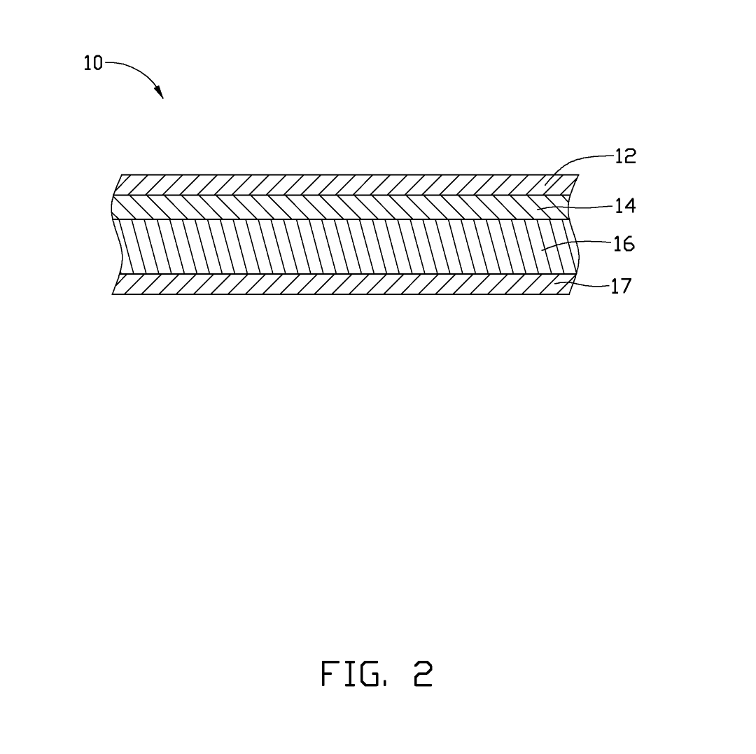

Referring FIG. 2, the touch screen 10 may be a transparent capacitive touch screen including a transparent protective layer 12, a first conducting layer 14, a transparent main body 16, a second conducting layer 17, a connecting wire 18, and a control module 19. The transparent protective layer 12 may be made of silicon dioxide (SiO) or polyethylene terephthalate (PET). The first conducting layer 14 is attached to the transparent protective layer 12, and may be made of indium tin oxide (ITO), aluminum-doped zinc oxide, or cadmium oxide (CdO). The first conducting layer 14 is configured for detecting a touch position. The transparent main body 16 is attached to the first conducting layer 14, and may be made of transparent glass or transparent plastic. The second conducting layer 17 is coated on the transparent main body 16, and may be made of transparent conducting material for shielding the transparent main body 16. The connecting wire 18 connects the touch screen 10 to a computer. The control module 19 may be an integrated chip disposed on the connecting wire 18 and electrically connected to the first conducting layer 14, the second conducting layer 17 and the connecting wire 18 by flexible cables (not shown). When the users touch the transparent protective layer 12, the control module 19 can detect a touch position coordinate made by the users, and produce a corresponding command signal to the electronic device.

The keyboard layer 30 may be adhered to the second conducting layer 17. The keyboard layer 30 includes a film 32, a number of key icons 34, and a driver circuit 36, both of the key icons 34 and the driver circuit 36 are attached to a first side of the film 32. The film 32 can be made of polyester or polyamide. The key icons 34 are made of transparent electroluminescence material, and can illuminate when the touch-type transparent keyboard 100 is powered on. Coordinate information of the key icons 34 is stored in the control module 19 corresponding to touch portions of the touch screen 10. By touching the key icons 34, the users can input a corresponding instruction, such as character, sign, or number to the electronic device. In response to the instruction, an image can be shown on a display of the electronic device. The driver circuit 36 can be made of transparent conducting material printed on the film 32, and electrically connecting the key icons 34 to the control module 19. The driver circuit 36 controls illumination of the key icons 34 when driver circuit 36 is powered on.

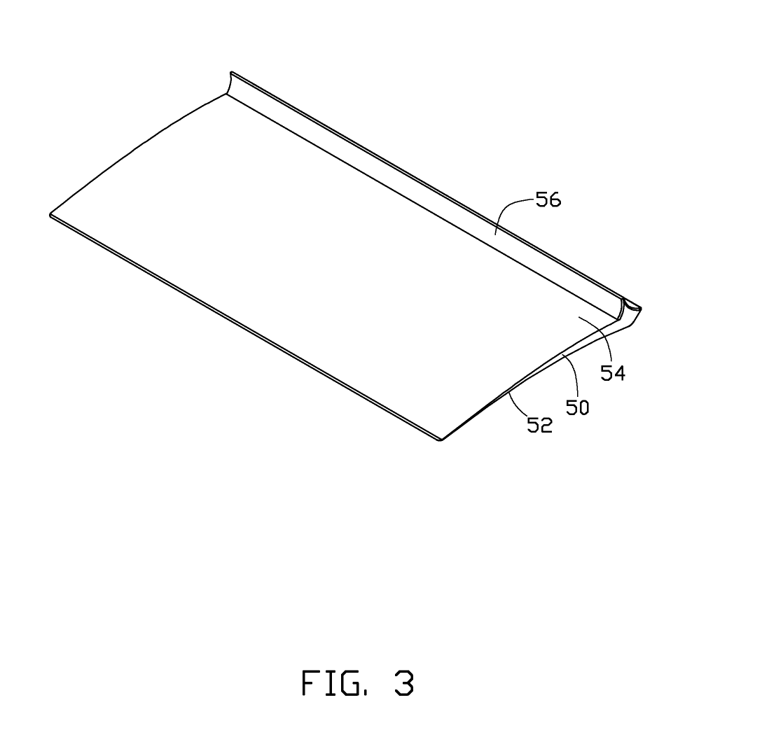

Referring FIG. 3, the transparent plate 50 can be made of transparent glass or transparent resin, and configured for supporting the keyboard layer 30 and the touch screen 10. The transparent plate 50 includes a first surface 52 and an opposite second surface 54. A second side of the film 32 opposite the first side may be adhered to the first surface 52. A supporting portion 56 is positioned on the second surface 54 to support the touch-type transparent keyboard 100. In the exemplary embodiment, the supporting portion 56 is made of transparent material and a cross section of the supporting portion 56 may be substantially triangular.

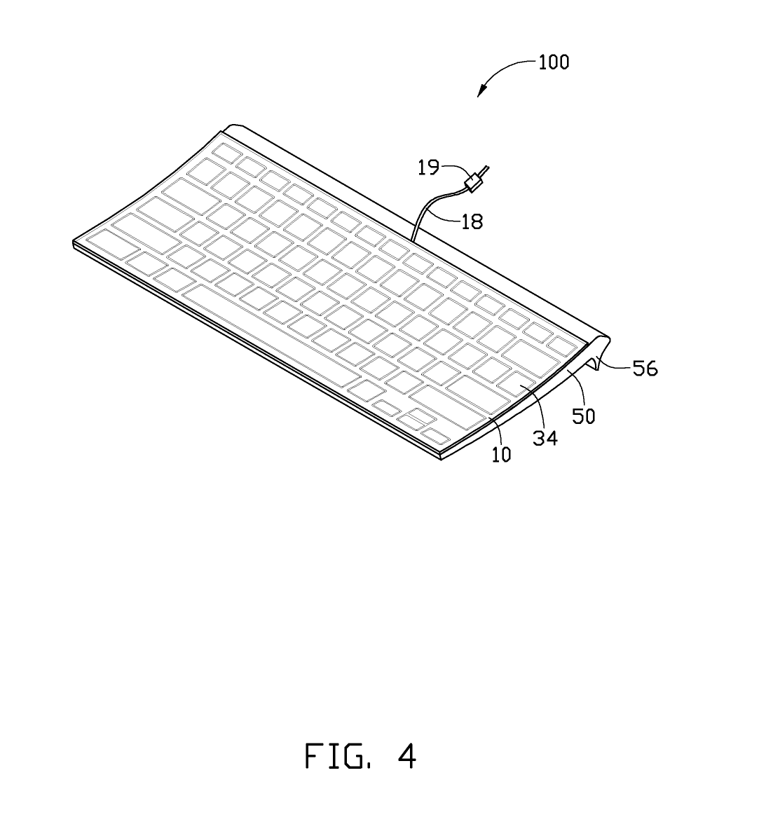

Referring FIG. 4, when the touch-type transparent keyboard 100 is powered on, the control module 19 triggers the driver circuit 36 to illuminate the key icons 34 and the key icons 34 are displayed through the touch screen 10. When users touch the touch screen 10, the control module 19 detects the touching position and records coordinate information corresponding to the touching position. Then, the control module 19 compares the coordinate information and the coordinate information of the key icons 34 to output the command signal corresponding to the touch position.

In another exemplary embodiment, the touch-type transparent keyboard 100 can be a wireless keyboard, the control module 19 can be disposed on a sidewall of the transparent plate 50, and made of transparent material.

In another exemplary embodiment, the touch screen 10 also can be a resistance-type touch screen or a surface acoustic wave touch screen.

The touch-type transparent keyboard 100 adopts the touch screen 10 covering on the keyboard layer 30 and the transparent plate 50. Therefore, when typing the touch-type transparent keyboard 100, there is no noise produced. Furthermore, the transparent protective layer 12 protects the touch screen 10, and there are no mechanical keys defining gaps therebetween and therefore can be easily cleaned.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A touch-type transparent keyboard, comprising:
a touch screen;
a control module electrically connected to the touch screen;
a transparent plate; and
a keyboard layer comprising a plurality of key icons and a driver circuit electrically connecting the key icons to the control module; the keyboard layer disposed between the touch screen and the transparent plate;
wherein the control module triggers the driver circuit to the illuminate the key icons, whereby, the key icons are displayed through the touch screen.

2. The touch-type transparent keyboard as claimed in claim 1, the keyboard layer comprises a film made of polyester or polyamide, the key icons and the driver circuit are attached to the film.

3. The touch-type transparent keyboard as claimed in claim 1, wherein the key icons are made of transparent electroluminescence material.

4. The touch-type transparent keyboard as claimed in claim 2, wherein the driver circuit is made of transparent conducting material printed on the film.

5. The touch-type transparent keyboard as claimed in claim 1, wherein the transparent plate is made of transparent glass or transparent resin.

6. The touch-type transparent keyboard as claimed in claim 5, wherein the transparent plate comprises a transparent supporting portion positioned on the transparent plate, a cross section of the supporting portion is triangular.

7. The touch-type transparent keyboard as claimed in claim 1, further comprising a connecting wire connected to the touch screen, the control module connected to the connecting wire.

8. The touch-type transparent keyboard as claimed in claim 7, wherein the touch screen comprises a transparent protective layer, a first conducting layer, a transparent main body, a second conducting layer, and a connecting wire stacked in turn; the control module electrically connects to the first conducting layer, the second conducting layer, and the connecting wire.

9. The touch-type transparent keyboard as claimed in claim 1, wherein the control module stores coordinate information association with the key icons and corresponding to touch positions of the touch screen.

10. A touch-type transparent keyboard for use with an electronic device, the touch-type transparent keyboard comprising:
a touch screen;
a control module electrically connecting to the touch screen;
a transparent plate;
a keyboard layer comprising a plurality of key icons; the keyboard layer disposed between the touch screen and the transparent plate; and
wherein when a touching position corresponding to the key icons of the touch screen are touched, the control module detects a touch position coordinate and produces a corresponding command signal to the electronic device, and an image is shown on the electronic device.

11. The touch-type transparent keyboard as claimed in claim 10, wherein the transparent plate further comprises a driver circuit electrically connecting the key icons to the control module, the control module triggers the driver circuit to illuminate the key icons, whereby, the key icons are displayed through the touch screen.

12. The touch-type transparent keyboard as claimed in claim 11, wherein the keyboard layer comprises a film made of polyester or polyamide, the key icons and the driver circuit are attached to the film.

13. The touch-type transparent keyboard as claimed in claim 12, wherein the driver circuit is made of transparent conducting material printed on the film.

14. The touch-type transparent keyboard as claimed in claim 10, wherein the transparent plate comprises a transparent supporting portion positioned on the transparent plate, a cross section of the supporting portion is triangular.

15. The touch-type transparent keyboard as claimed in claim 10, further comprising a connecting wire connecting to the touch screen, the control module connected to the connecting wire.

16. The touch-type transparent keyboard as claimed in claim 15, wherein the touch screen comprises a transparent protective layer, a first conducting layer, a transparent main body, a second conducting layer, a connecting wire stacked in turn; the control module electrically connects to the first conducting layer, the second conducting layer, and the connecting wire.

17. The touch-type transparent keyboard as claimed in claim 10, wherein the control module stores coordinate information associated with the key icons and corresponding to touch positions of the touch screen.
